(19) United States
(12) Patent Application Publication
(10) Pub. No.: US 2025/0185642 A1
(43) Pub. Date: Jun. 12, 2025

(54) COMPUTER-IMPLEMENTED METHOD FOR PROVIDING VARIABLE APPLICATION RATE DATA

(71) Applicant: BASF AGRO TRADEMARKS GMBH, Ludwigshafen (DE)

(72) Inventors: Hubert SCHMEER, Odenthal (DE); Maria TACKENBERG, Münster (DE); Thomas LECHNER, Münster (DE); Jerome CASADEBAIG, Lyon (FR); Christian COMBERG, Wuelfrath (DE); Johannes Moritz STAEBLER, Koeln (DE); Damon RAEIS-DANA, Koeln (DE); Anna Katarina CROCKFORD, Buckinghamshire (GB); Bjoern KIEPE, Köln (DE); Nicolas WERNER, Koeln (DE)

(21) Appl. No.: 18/845,362

(22) PCT Filed: Mar. 9, 2023
(86) PCT No.: PCT/EP2023/056044

§ 371 Date: Sep. 9, 2024

(30) Foreign Application Priority Data
Mar. 10, 2022 (EP) 22161461.3

(51) Int. Cl. A01M 7/00; A01C 21/00

(52) U.S. Cl. CPC A01M 7/0089; A01C 21/005

(57) ABSTRACT

A computer-implemented method for providing variable application rate data for at least two application means of an application system of an application device for applying a treatment product onto an agricultural field, comprising: providing application configuration parameter data for the at least two application means of the application system of the application device; providing position and/or movement data of the application device; providing product application data comprising spatial information about the target application amount for the treatment product to be applied onto the agricultural field; generating a grid of application polygons; and determining variable application rate data for each of the at least two application means of the application system of the application device based on the application configuration parameter data, the position and/or movement data, and the product application data, wherein the variable application rate data is determined for each application polygon in the generated grid.

### TECHNICAL FIELD

The present disclosure relates to a computer-implemented method for providing variable application rate data for at least two application means of an application system of an application device for applying a treatment product onto an agricultural field, a system for providing variable application rate data, an application device for a variable rate application of treatment products onto an agricultural field, a use of control data for an application device, and a computer program element.

### TECHNICAL BACKGROUND

The general background of this disclosure is the treatment of an agricultural field. The treatment of an agricultural field comprises the treatment of the soil and the application and/or the treatment of the seeds and plants in/on the agricultural field, a greenhouse, or the like.

In common agricultural practice, for example satellite image-based vegetation maps are used to produce sprayer application maps with variable rates based on differentiations of indices like Leaf Area Index (LAI) or Normalized Difference Vegetation Index (NDVI), soil texture and/or organic matter in order to provide application maps. However, the application rate is only read/determined at the mounting position of a global positioning receiver of the application device, e.g. tractor, self-propelled sprayer etc., but not at a plurality of positions over the whole extend of an application system (e.g. sprayer boom or sprayer width etc.) being arranged at the application device and comprising at least two application means.

Hence, in conventional agricultural practice, the application rate of the treatment products is adjusted on the basis of heterogeneity maps and the position of the receiver of the application device in the maps, wherein the application rate of the treatment products is constant over the whole width of the application system and therefore is the same for each application means (e.g. a nozzle). However, since the application systems being arranged at an application device extends faraway from the receiver, e.g. a sprayer boom extends in the range of 6 to 54 meters, and the demand of a treatment product/application rate of a treatment product differs over the whole width of the application system, in conventional agricultural practice a non-optimal treatment/application rate of treatment products on an agricultural field is provided.

It has been found that a need exists to provide a variable rate application with a higher resolution, in particular over the whole width of the application system, in order to improve the effects of the treatment products to avoid unnecessary treating and/or over treatment of the agricultural field, and to save money and amounts of treating products.

### SUMMARY OF THE INVENTION

In one aspect of the present disclosure, a computer-implemented method for providing variable application rate data for at least two application means (e.g. two nozzles) of an application system (e.g. spray applicator) of an application device (e.g. a sprayer) for applying a treatment product onto an agricultural field is provided, comprising: providing application configuration parameter data for the at least two application means of the application system of the application device;
providing position and/or movement data of the application device;
providing product application data comprising spatial information about the target application amount for the treatment product to be applied onto the agricultural field (e.g. an application map);
generating a grid of application polygons (e.g. rectangles, triangles, hexagons or other geometries); and
determining variable application rate data for each one of the at least two application means of the application device based on the application configuration parameter data, the position and/or movement data, and the product application data,
wherein the variable application rate data is determined for each application polygon in the generated grid.

In a further aspect of the present disclosure, a system for providing variable application rate data for at least two application means of an application system of an application device for applying a treatment product onto an agricultural field is provided, comprising: a application configuration parameter data providing unit providing application configuration parameter data for the at least two application means of the application system of the application device;
a position and/or movement data providing unit for providing position and/or movement data of the application device;
a product application data providing unit for providing product application data comprising spatial information about the target application amount for the treatment product to be applied onto the agricultural field;
a generating unit for generating a grid of application polygons; and
a determining unit for determining variable application rate data for each one of the at least two application means of the application system of the application device based on the application configuration parameter data, the position and/or movement data, and the product application data, and/or treatment product properties,
wherein the variable application rate data is determined for each application polygon in the generated grid.

In a further aspect, an application device for a variable rate application of treatment products onto an agricultural field controlled by control data is presented.

In a further aspect, a use of control data obtained by the method disclosed for providing variable application rate data for a treatment product is presented.

In a further aspect a computer program element, in particular a computer program product or a computer readable medium, with instructions, which when executed on computing device(s) is configured to carry out the steps of any of the method disclosed herein in a system disclosed herein is presented.

This and embodiments described herein relate to the method, the system, the treatment device, the computer program element lined out above and vice versa. Advantageously, the benefits provided by any of the embodiments and examples equally apply to all other embodiments and examples and vice versa.

As used herein “determining” also includes “estimating, calculating, initiating or causing to determine”, “generating” also includes “initiating or causing to generate”, and “providing” also includes “initiating or causing to determine, generate, select, send, query or receive”.

The method, device, system, computer program element, disclosed herein provide an efficient, sustainable and robust way for providing a variable rate application with a high resolution in order to increase the effectivity, i.e. the application of the treatment product in a correct rate with an amount fulfilling the demand of a treatment products of the agricultural field, of the application of treatment products on the agricultural field. The present disclosure allows that the application maps, which are provided with comparatively high resolution, can now also be matched more accurately by the application device, even if only the position/movement of the application device is used to control the application means. Notably, it may often happen in practice that the application device whose position in the application map is used to control the application means is located in a different application amount area than the respective application means and/or the application system, i.e. it may happen that the position of the application device, in the application map, corresponds to an application amount that does not match the application amount of the position of the application system and/or the application means. The present disclosure provides the possibility to better map a high resolution of a provided application map by controlling the application means accordingly, even if only the position/movement of the application device is available. In other words, the present disclosure allows that the application maps, which are provided with comparatively high resolution, can now also be matched more accurately by the application device/means, even if only the position/movement of the application device is used to control the application means. It should be noted that although it is theoretically possible to acquire the position of each individual application means in the application map, e.g. via Global Navigation Satellite System (GNSS), in particular GPS units and/or camera units arranged accordingly on the application means, such an approach is too expensive in practice and may also considerably increases the weight of an application system. In many cases, such an approach is not possible in practice, since in this case considerable modifications to the application system and/or the application device would be necessary due to the increase in weight. The system for providing variable application rate data for at least two application means of an application system of an application device for applying a treatment product onto an agricultural field may be arranged on an agricultural device or agricultural system, and/or on a server being spatially separated from the agricultural field, e.g. a server, but is not limited thereto. Therefore, the system may be on-board or web-based.

It is an object of the present invention to provide an efficient, sustainable and robust way for providing a variable rate application with a high resolution in order to increase the effectivity of the application of treatment products, avoiding unnecessary treating and/or over treatment of the agricultural field, and saving money and amounts of treating products.

These and other objects, which become apparent upon reading the following description, are solved by the subject matters of the independent claims. The dependent claims refer to preferred embodiments of the invention.

The term agricultural field as used herein is to be understood broadly in the present case and presents any area, i.e. surface and subsurface, of a soil to be treated by e.g. seeding, planting and/or fertilizing. The agricultural field may be any plant or crop cultivation area, such as a farming field, a greenhouse, or the like. A plant may be a crop, a weed, a volunteer plant, a crop from a previous growing season, a beneficial plant or any other plant present on the agricultural field. The agricultural field may be identified through its geographical location or geo-referenced location data. A reference coordinate, a size and/or a shape may be used to further specify the agricultural field.

The term size, the location and/or the shape of the application polygon as used herein is to be understood broadly in the present case and presents the form, the geographical position, the spatial extent, and the orientation of the application polygon. The application polygon may be a rectangle or a triangle, but is not limited thereto. Exemplary, the minimum width of a cell of the application polygon can be equal to either the nozzle spacing (i.e., distance between nozzles) or equal to the width of the spray cone at the ground, but is not limited thereto. In this context, the minimum width, orthogonal to the tram line or moving direction of the application device, of a cell of the application grid may be in a range of 0.05 m to 12.0 m, preferably 25 cm or 50 cm. Further, exemplary, the minimum length, in movement direction of the application device, of a cell of the application polygon depends on the driving speed of the application device and the dosage control latency of the nozzle, i.e. the time it takes the nozzle to change dosage rates, which is the sum of signal latency and mechanical latency. In this context, the minimum length of a cell of the application polygon may be in a range of 0.05 m to 50 m, preferably 25 cm to 1.0 m, but is not limited thereto. In an exemplary determination of the minimum length of a cell of the application polygon, the minimum length is 5 meter, when the speed is 18 km/h and the dosage control latency is 1 s, e.g. s=18 km/h=5 m/s; d=1 s; length=s/d=5 m/s/1 s=5 m.

Alternatively, the size, the location and/or the shape of the application polygon is configured in such a manner that the application system at least partially covers its width at least eight, in particular more than 10, application polygons during a treatment of the agricultural field. The term covers as used herein is to be understood broadly in the present case and defines the area of the surface of the agricultural field, above which, during treatment of the agricultural field, the application system is arranged, held and/or guided by the application device in a small height, i.e. 10 to 50 cm. In other words, only that part of the surface of the agricultural field that is completely or at least partially covered by the width of the application system is covered during the treatment.

Alternatively, the size, the location and/or the shape of the application polygon is based on at least two different parameters of the product application data, at least two different parameters of the position and/or movement data, the provided tramlines of the application device and the application configuration parameter data.

The term seeding, drilling or planting as used herein is to be understood broadly in the present case and presents any action to put, place or bring in seeds in a soil area of an agricultural field. Seed, e.g. seed grain or seed fruit, is any biological plant material that refers to dry, dormant, generative reproductive organs such as seeds, fruits, pseudo-fruits, infructescences or parts thereof. Seeds contain the complete germ system of the plants, created by fertilization, and contains germination and growth potential. The term planting as used herein is to be understood broadly in the present case and presents any action to put, place or bring in seeds or grown plants and/or seedlings or cuttings in a soil area of an agricultural field. Seedlings are young sporophyte developing out of a plant embryo from a seed.

The term fertilizing as used herein is to be understood broadly in the present case and presents any action to put, place or bring in fertilizers in a soil area of an agricultural field. A fertilizer is any material of natural or synthetic origin that is applied to soil or to plant tissues to supply plant nutrients.

The term treatment product used herein is to be understood broadly in the present case and represents any object or material useful for the treatment. In the context of the present disclosure, the term treatment product includes but is not limited to: chemical products such as fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, or any combination thereof; biological products such as microorganisms useful as fungicide (biofungicide), herbicide (bioherbicide), insecticide (bioinsecticide), acaricide (bioacaricide), molluscicide (biomolluscicide), nematicide (bionematicide), avicide, piscicide, rodenticide, repellant, bactericide, biocide, safener, plant growth regulator, urease inhibitor, nitrification inhibitor, denitrification inhibitor, or any combination thereof; fertilizer and nutrient; but also seeds and seedlings; plants; water, and any combination thereof. Instead of the term treatment product, alternatively the term indication or agronomic indication may also be used.

The term application means used herein is to be understood broadly in the present case and represents any device or apparatus being configured to treat or apply a treatment product onto an agricultural field. For instance, the application means may be at least one outlet or a plurality of outlets, e.g. nozzles of a sprayer or outlets of a spreader, coulters of a planter/seeder/drill for applying the treatment products onto the agricultural field. The application means is/are arranged at the application system. Further, the application means may be a section of the application system comprising a plurality of single application means.

The term application system used herein is to be understood broadly in the present case and represent any holder or mounting of the application means, wherein the application system is mounted, coupled or arranged directly at the application device. Exemplary, the application system may be a sprayer boom, a fertilizer spreader boom, an arm of a seeder/planter/drill or disc spreader with section control but is not limited thereto. At least one, in particular a plurality of, application means are arranged at the application system.

The term application device used herein is to be understood broadly in the present case and represents any device being configured to provide/spread seeds, plants and/or fertilizers onto the soil of an agricultural field. The application device may be configured to traverse the agricultural field. The application device may be a ground or an air vehicle, e.g. a rail vehicle, a robot, an aircraft, an unmanned aerial vehicle (UAV), or the like. The application device can be an autonomous or a non-autonomous application device.

The term application configuration parameter data used herein is to be understood broadly in the present case and represents any data/parameter of the configuration of the application means, the agronomic usage and/or the application system, in particular information/data which may allow to derive the position and/or movement of the application means with respect to the application device and/or the application system, so that it can be derived directly or indirectly, where the respective application means are located with respect to the provided product application data/application map and thus the correct amount of treatment product can be set for the position of the respective application means. For instance, the application configuration parameter data include the width of the application system, e.g. sprayer boom, the fertilizer spreader width or the seeder/planter width, but is not limited thereto. Exemplary, a sprayer boom may have a width of 3.0 m to 54.0 m, in particular 12.0 m to 42.0 m, but is not limited thereto. The sprayer boom may extend in multiple sections having a width of 3.0 m, but is not limited thereto. Further, exemplary, a fertilizer spreader may have a width of 3-42 m, but is not limited thereto, and a planter/drill may have a width of 3-24 m, but is not limited thereto.

Further, the application configuration parameter data may include the number of application means, e.g. spray nozzle or spreader outlets, the position of the application means at the application system, the type of the application means, i.e. single application mean or a plurality of application means at a section of the application system, the distance between the application means, and the technical properties, e.g. providing rate/flow rate, of the application means and/or the geometry of the application system and/or the application means (e.g. angle, sections with respect to the application device), the size of the treatment area. In this respect, the application configuration parameter data may also comprise vector data representing the angle and distance of a respective application means to the application device so that based on this vector data the relative position of the respective application means to the detected position of the application device can be determined. This data may also include geometry information of the application means relative to the application system and geometry information of the application system relative to the application device. In this case, the position/movement of the application means from the application device to the application system to the application means could be determined. The application configuration parameter data may be provided as an input by a user via a user interface and/or an automatically input via a control unit of the application means and/or of the application system, but is not limited thereto.

Further, alternatively or additionally, the application configuration parameter data may include agricultural treatment type data, indicating the type of the treatment of the agricultural field. For instance, types of the treatment may be applying solid treatment product, e.g. seeding, fertilizing with solid fertilizer, etc., and/or applying fluid treatment product, e.g. fertilizing with liquid fertilizer, but are not limited thereto. A plurality of further, more specific, types of the treatment can also be included in the agricultural treatment type data. In this context, the agricultural treatment type data can also include information about the application proceedings of specific treatment products, the product label with use instructions, the product profile, e.g., product rate flexibility or product rate dependence on for example soil texture and/or soil organic matter and/or biomass.

The term variable application rate data used herein is to be understood broadly in the present case and represents any data indicating/initiating or triggering an application rate of a treatment product being variable with respect to whole width of an application system of an application device, i.e. being separately provided for each application means being arranged at the application system. The variable application rate data comprises a high resolution, if the variable application rate data refers to data of a single application means or a plurality of application means being arranged at a section of the application system. In other words, the variable application rate data have a high resolution when only single application means or a plurality of application means being arranged at a section of the application system, wherein the section of the application system is smaller than the whole extend of the application system, are indicated/included by the data. The variable application rate data may include values for the amount and/or treating time of treatment products to be applied on the agricultural field having the unit second, liter, milliliter, kilogram, or gram. The variable application rate data may be provided as a map. The term map represents that data are arranged in a geographical coordinate system.

The term position and/or movement data used herein is to be understood broadly in the present case and represents any data indicating the position and/or the movement, i.e. direction and speed, of an agricultural application device on an agricultural field. The position and/or movement data may include the position defined by longitude and latitude, the movement speed in m/s or km/h and/or the movement direction/heading in degree, the acceleration, velocity, etc. but is not limited thereto. The position and/or movement data may be generated and provided in real-time during the application of a treatment product, or may be derived from data recorded during a previous application, or may be derived from anticipated and/or predicted data before the application, but is not limited thereto.

The term product application data used herein is to be understood broadly in the present case and represents any data indicating/depicting at which position in the agricultural field which amount of a treatment product should be applied/provided. In an example, the product application data is provided by means of an application map (“to-be-applied-map” or “prescription map”). Product application data thus comprises heterogeneity data and a mapping of at least two amounts of a treatment product to the at least two values or categories of the heterogeneity data. Heterogeneity data may be provided by means of point data, polygon data or raster data, but is not limited thereto. Heterogeneity data may be based on or derived from the treatment product properties (product indication, profile, biological and phys.-chem. properties) in relation to field heterogeneity, wherein field heterogeneity may be based on biomass data, soil parameters, NDVI or LAI data, crop data derived from remote sensing data, long term crop data derived from remote sensing data, soil data derived from measurements of physical and/or chemical and/or biological soil properties through soil samples and/or stationary soil sensors and/or mobile soil sensors, soil data derived from long term remote sensing data, soil data derived from statistical analyses, elevation data and/or slope data derived from digital elevation models and/or digital surface models and/or digital terrain models and/or remote sensing data, crop yield data, in particular weighted or non-weighted crop yield data, long term crop yield data, crop data and/or soil data and/or elevation data and/or slope data and/or crop yield data derived from agricultural implement mounted sensors systems, scouting data of specific weed and/or nematode and/or pest and/or disease infestations derived from cameras and/or drones and/or visual map entries and/or historical data, application data of previous applications of treatment products, a heuristic and/or weighted and/or non-weighted combination of at least two of the preceding datasets. The mapping of treatment product rates, i.e., the amount at which to apply a treatment product, to the heterogeneity data may be based on product label data, regulatory data, an expert model and/or assessment, and/or a machine learning model, but is not limited thereto.

The term tramlines used herein is to be understood broadly in the present case and represents any line indicating/corresponding to a track, i.e. area of an agricultural field on which the tires of a e.g. sprayer or spreader runs over the agricultural field, in order to traverse the agricultural field. Exemplary, the tramlines may be the intermediate areas between two adjacent crop planting rows of an agricultural field. The crop planting rows are a conventional arrangement of crop plants on a cultivation area. Based on the semi-automated or fully-automated sowing of crop plants on a cultivation area by agricultural machinery, normally seeds of crop plants are arranged in lines or rows, such that the growth of the crop plants can be efficiently monitored, the treatment of crop plants can be efficiently provided, and the harvest of the crop plants can be precisely predetermined. Further, exemplary, the tramlines may be any freely selectable track (AB-line) in order traverse an agricultural field. The tramlines may be straight lines, odd lines like curves, but are not limited thereto. Tramlines may be lines being previously defined, i.e., being defined before an application device traverses the agricultural field, or currently defined, i.e., being defined during an application device traverses the agricultural field. The term AB-line defines the connecting line between at least two geo-positions which is used as a reference line in order to produce the layout of the grid of smaller polygons of a high-resolution application map.

The term treatment area used herein is to be understood broadly in the present case and represents the area being directly below the application means and therefore being the area which is at the same time treated by the application means.

The control data as used herein is to be understood broadly in the present case and relates to any data configured to operate and control an application device. The control data are provided by a control unit and may be configured to control one or more technical means of the device, e.g. the drive control but is not limited thereto.

In an embodiment of the method for providing variable application rate data, the application configuration parameter data comprises information about the width of the application system, the number of application means, the type of the application means, the distance between the application means, the distance of the application means from the application device, the type of control of the application means, the size of the treatment area treatable by the application means, technical properties of the application device and/or the application means. The use/providing of the application configuration parameter data enables to adapt the determining of the variable application rate data with respect to a unique application configuration/configuration of the application system. Therefore, an efficient, sustainable and robust way for providing a variable rate application with a high resolution in order to increase the effectivity of the application of the treatment products onto an agricultural field can be provided.

In an embodiment of the method for providing variable application rate data, the position and/or movement data are Global Navigation Satellite System, GNSS, in particular GPS data and/or Real Time Kinematic, RTK, system data of the application device and/or of the application means, and/or wherein the position and/or movement data comprises information about the geographical position of the application device, the geographical position of the application means, the speed of the application device and/or the movement direction of the application device. The use of the global positioning system, GNSS, GPS, and/or the real-time kinematic positioning, RTK, enables an accurate, precise, and error-free determining/estimation of the current position and/or movement, i.e., direction and speed of the moving object, of the application device. Therefore, an efficient, sustainable and robust way for providing a variable rate application with a high resolution in order to increase the effectivity of the application of treatment products onto an agricultural field can be provided.

In an embodiment of the method for providing variable application rate data, the step of determining variable application rate data for each one of the at least two application means of the application device is performed by the following steps:
determining the position and/or movement of each one of the at least two application means based on the application configuration parameter data and the position and/or movement data of the application device; and
determining the variable application rate data based on the position and/or movement of the at least two application means and the product application data/application map for each application polygon.

In this embodiment, the step of determining variable application rate data for each one of the at least two application means of the application system of the application device may be substituted by the steps: determining the position and/or movement of each one of the at least two application means based on the application configuration parameter data and the position and/or movement data of the application device; and determining the variable application rate data based on the position and/or movement of the at least two application means and the product application data/application map.

In an embodiment of the method for providing variable application rate data, the product application data may be provided as an application map with polygons. The polygon size may be optimized and/or adapted with respect to the treatment product to be applied onto the agricultural field. In an example, the product application data is provided as an application map with an optimized polygon size for a specific treatment product to be applied onto the agricultural field.

In an embodiment of the method for providing variable application rate data, wherein the size, the location and/or the shape of the application polygon is based on the product application data, and/or the position and/or movement data, and/or provided tramlines of the application device, and/or the application configuration parameter data as well as the properties of the treatment product.

The creation of the polygons is based on the vectorization of heterogeneity data which were captured by various means.

In an example embodiment of the method for providing variable application rate data, the size, the location and/or the shape of the application polygon is based on the application configuration parameter data. By taking into account the application configuration parameter data, i.e., the width of the boom, the individual application polygons, as well as the grid of application polygons, and the variable application rate data can be adapted to the characteristics of the used application device, application system and/or application means. Therefore, the size, the location and/or the shape of the application polygons may change when determined/provided for a small application device, e.g., a golf course sprayer, or a larger application device, e.g. a self-propelled sprayer. The size, the location and/or the shape of the application polygons can equally be adapted to the agronomic needs and/or the technical profile of a treatment product and may therefore change when determined/provided for a residual soil herbicide or a mineral fertilizer.

In an embodiment of the method for providing variable application rate data, further comprises the step of providing control data for at least one, preferably at least two, application means for a variable rate application of a treatment product onto the agricultural field based on the variable application rate data provided as a high resolution polygon grid.

In an embodiment of the system for providing variable application rate data fora treatment product, further comprises a control data providing unit for providing control data for at least one, preferably at least two, application means or application devices for a variable rate application of a treatment product which is to be applied onto the agricultural field based on the variable application rate data.

In an embodiment of the application device system for a variable rate application (VRA) of a treatment product onto an agricultural field, the application device is a sprayer comprising either pulse width modulation (PWM) nozzles and/or electronically controlled multi nozzle heads or other VRA devices, for example Vortex nozzles, but is not limited thereto. The application device can also be a spreader with single section or section-outlet control, but is not limited thereto. The application device can also be a planter/drill with single seed coulter control allowing single application means (single device) or section control, but is not limited thereto.

Applicators with the described devices allow an efficient, sustainable and robust way for providing a variable rate application with a high resolution in order to increase the effectivity of the application of the treatment products onto an agricultural field. The subject matter of the patent is to deliver the required digital application data and/or instructions for various application devices at a high resolution.

### BRIEF DESCRIPTION OF THE DRAWINGS

In the following, the present disclosure is further described with reference to the enclosed figures:

FIG. 1 illustrates a flow diagram of a computer-implemented method for providing variable application rate data;

FIG. 2 is a schematic illustration of a system for providing variable application rate data;

FIG. 3 illustrates a schematic illustration of an application device for a variable rate application of treatment products onto an agricultural field;

FIGS. 4-8 illustrate examples of application maps in which exemplary tramlines are indicated;

FIGS. 9, 10a,

10b and 10c illustrate application maps in which exemplary tramlines are indicated; and

FIG. 11 illustrates exemplarily the different possibilities to receive and process field data.

### DETAILED DESCRIPTION OF EMBODIMENTS

The following embodiments are mere examples for implementing the method, the system or application device disclosed herein and shall not be considered limiting.

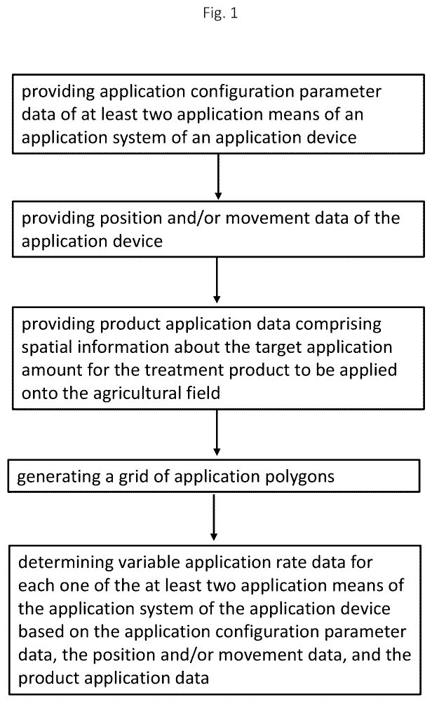

FIG. 1 illustrates a flow diagram of a computer-implemented method for providing variable application rate data. The method steps shown in FIG. 1 may be executed by the systems.

In a first step, application configuration parameter data for the at least two application means of the application system of the application device are provided by a first providing unit. The at least two application means may be sprayer nozzles (application means) being arranged at a sprayer boom (application system) being attached to a sprayer/tractor (application device). The provided application configuration parameter data may comprise information about the width of the application system, the number of application means, the type of the application means, the distance between the application means, the height of the application means above ground, the distance of the application means from the application device, the type of control of the application means, the size of the treatment area treatable by the application means, technical properties of the application device and/or the application means.

In a second step, position and/or movement data of the application device are provided. The position and/or movement data of an application device may be provided by a second providing unit. The position data may be defined by longitude and latitude and the movement data, i.e. the speed and the movement direction, may be defined in m/s and degree. The position and/or movement data may be provided by a GPS system.

In a third step, product application data comprising spatial information about the target application amount for the treatment product to be applied onto the agricultural field is provided, e.g. by means of an application map. The product application data/application map is provided by the third providing unit and may be received from a database system.

In a fourth step, a grid of application polygons is generated based on the application configuration data.

In a fifth step, variable application rate data for each one of the at least two application means of the application system of the application device is determined. The determining of the variable application rate data is based on the application configuration parameter data, the position and/or movement data, and the product application data/application map of the agricultural field, wherein the variable application rate data is determined for each application polygon in the generated grid. The variable application rate data may include the application rate for each of the at least two application means being arranged at the application system of the application device. The determined variable application rate data may include values for the amount of treatment products to be applied on the agricultural field at the respective position.

FIG. 2 is a schematic illustration of a system 10 for providing variable application rate data of a treatment product to be applied onto an agricultural field.

The system 10 comprises a first providing unit 11 for providing application configuration parameter data of each one of at least two application means of an application system of an application device. The application configuration parameter data can be provided by a user via a user interface or via an electrically data connection, i.e. by-wire or wireless, of the application system and the first providing unit 11. The first providing unit 11 provides the application configuration parameter data to the system 10 for further proceeding. Further, the system 10 comprises a second providing unit 12, a third providing unit 13, and a determining unit 14. The second providing unit 12 is configured to provide position and/or movement data, e.g. via a GNSS/GPS system of the application device. The second providing unit 12 may comprise at least one antenna for transmitting and/or receiving signals for the determining of the position. The second providing unit 12 provides the position and/or movement data to the system 10 for further proceeding. The third providing unit 13 is configured to provide product application data, e.g. by means of an application map, comprising spatial information about the target application amount for the treatment product to be applied onto the agricultural field. The third providing unit 13 may receive or query the product application data/application map from a database system or determines the product application data from meta data, e.g. remote sensing data (satellite data) or soil property data. The third providing unit 13 may comprise an antenna and/or an interface for receiving the product application data or the meta data. The third providing unit 13 provides the product application data/application map to the system 10 for further proceeding. The determining unit 14 is configured to determine variable application rate data for each one of the at least two application means of the application system of the application device based on the application configuration parameter data, the position and/or movement data, and the product application data/application map. The determining unit 14 receives the provided application configuration parameter data from the first providing unit 11, the provided position and/or movement data from the second unit 12, and the provided product application data/application map from the third providing unit 13 in order to use these data for a determining of the variable application rate data for each one of the at least two application means. The determining unit 14 may provide the determined variable application rate data for each one of the at least two application means to the system 10 for further proceeding. Optionally, the determining unit 14 may include a moving direction determining unit 16, a vectorization unit 17, and a treatment area identification unit 18. The moving direction determining unit 16 may be configured to determine a moving direction of an application device based on its position and/or movement data and to determine tramlines in the product application data/application map. The moving direction determining unit 16 receives the position and/or movement data and the heterogeneity map for determining the moving direction and/or the tramlines. The moving direction determining unit 16 provides the determined moving direction and/or the tramlines to the determining unit 14 for further proceeding. The vectorization unit 17 may be configured to vectorizing the moving direction and/or the tramlines in the product application data/application map of agricultural field. The vectorization unit 17 receives the determined moving direction and/or the tramlines from the moving direction determining unit 16, uses these in order to vectorize the moving direction and/or the tramlines, and provides the vectorized moving direction and/or the tramlines to the determining unit 14 for further proceeding. The treatment area identification unit 18 is configured to identify a treatment area. The treatment area identification unit 18 receives the determined moving direction, the vectorized tramlines in the application map of an agricultural filed, and the application configuration parameter data, identifies the treatment area, and provides the treatment area to the determining unit 14 for further proceeding. Optionally, the system 10 may comprise a control data providing unit 15 for providing control data for at least one, preferably at least two, application means for a variable rate application of a treatment product to be applied onto an agricultural field based on the variable application rate data. The control data providing unit 15 receives the determined variable application rate data for each one of the at least two application means from the determining unit 14 and uses these data in order to provide control data. Further, the system comprises a generating unit 19, which may generate a grid of application polygons and which may also be configured to adapt the size and shape of the application polygons. Notably, the size, the location and/or the shape of the application polygon is based on the application configuration parameter data. By taking into account the application configuration parameter data, i.e., the width of the boom, the individual application polygons, as well as the grid of application polygons, and the variable application rate data can be adapted to the characteristics of the used application device, application system and/or application means. Therefore, the size, the location and/or the shape of the application polygons may change when determined/provided for a small application device, e.g., a golf course sprayer, or a larger application device, e.g. a self-propelled sprayer. The size, the location and/or the shape of the application polygons can equally be adapted to the agronomic needs and/or the technical profile of a treatment product and may therefore change when determined/provided for a residual soil herbicide or a mineral fertilizer.

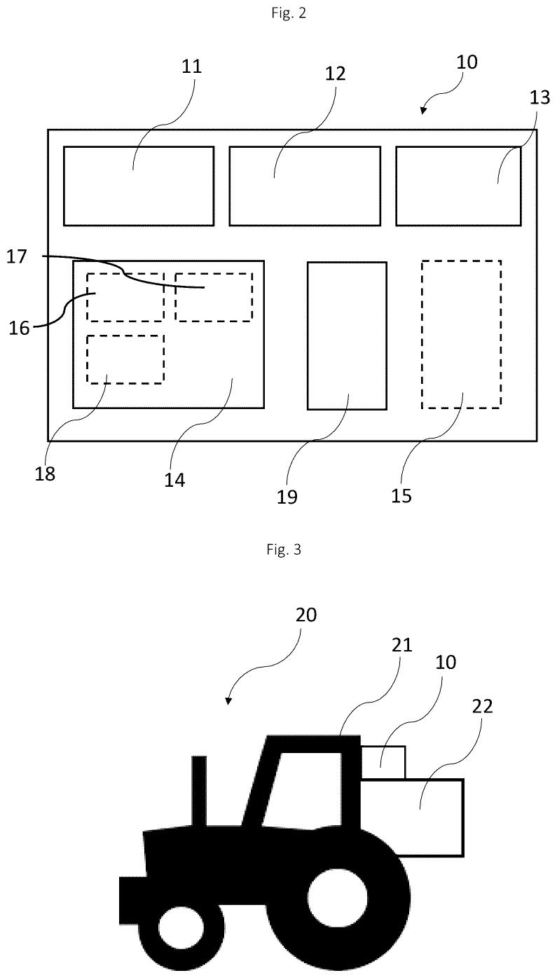

FIG. 3 illustrates a schematic illustration of an application device 20 for a variable rate application of treatment products onto an agricultural field. A system 10 for providing variable application rate data for a treatment product, which is to be applied onto an agricultural field, and application system 22, e.g. a sprayer boom comprising a plurality of application means, is coupled, i.e. electrically and mechanically connected, to a vehicle 21 of the application device 20.

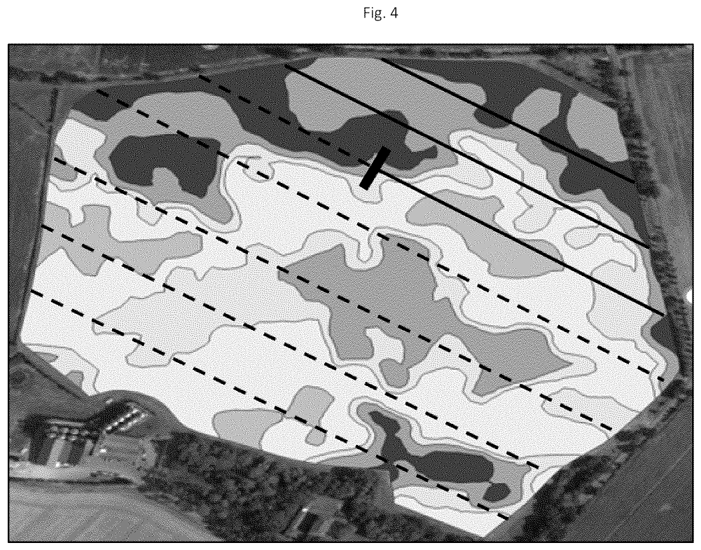

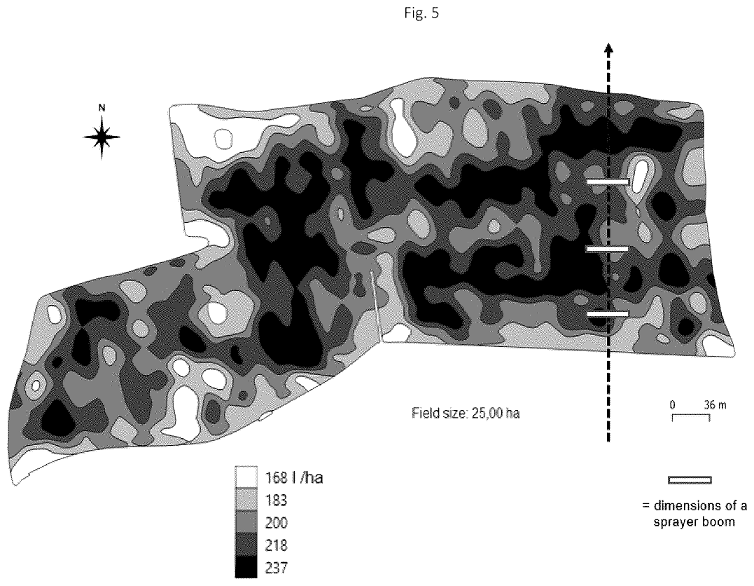

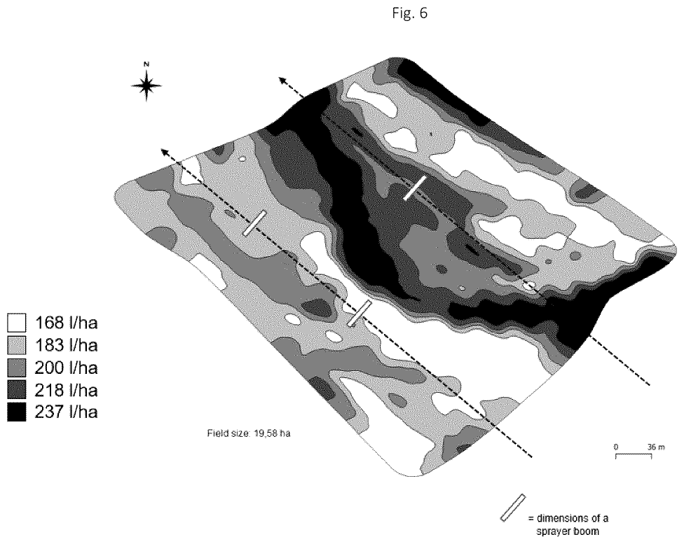

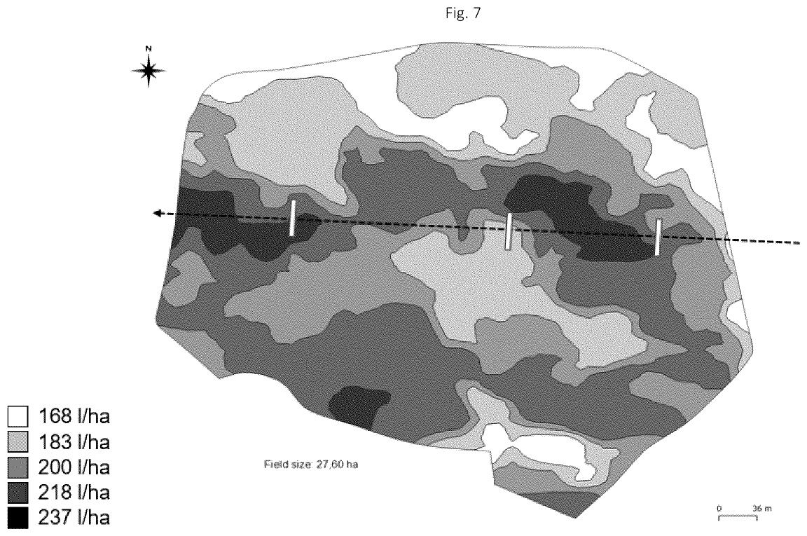

FIGS. 4 to 7 illustrate examples of application maps in which exemplary tramlines and/or movement directions of the application device are indicated. The figures show examples of individual tramlines and/or movement directions of the application device. The application device moves through the field along these tramlines. As can be seen in the figures, it can often happen that the position of the application device in the application map corresponds to an application amount that does not match the application amount of the position of the application system, e.g. a sprayer boom. In other words, it often happens that the position of the application device corresponds to an application amount that does not match the application amount of the underlying application map. In contrast, the present disclosure provides the possibility to accurately implementing a given application map by controlling the application means according to high resolution application polygons, even if only the position/movement of the application device is available.

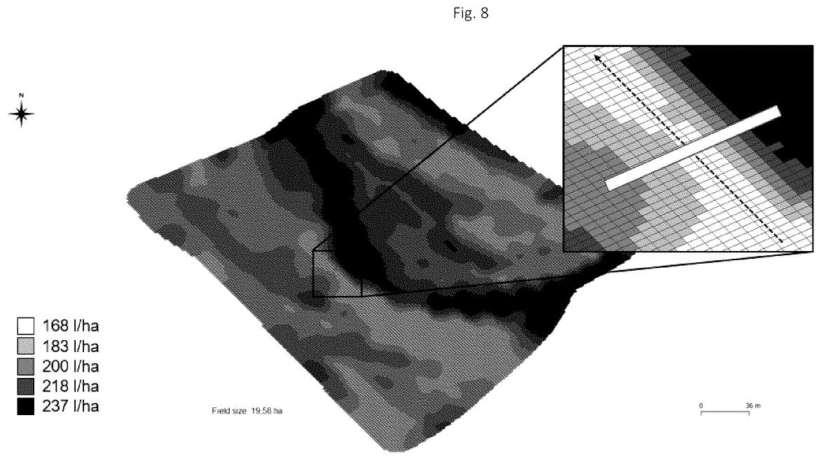

FIG. 8 illustrates an embodiment where a grid of application polygons has been generated, wherein the size, the location and/or the shape of the application polygon is based on the product application data, the provided tramlines of the application device, the position and/or movement data and/or the application configuration parameter data. Based on the generated grid the variable application rate data is determined as explained above for each application polygon in the generated grid.

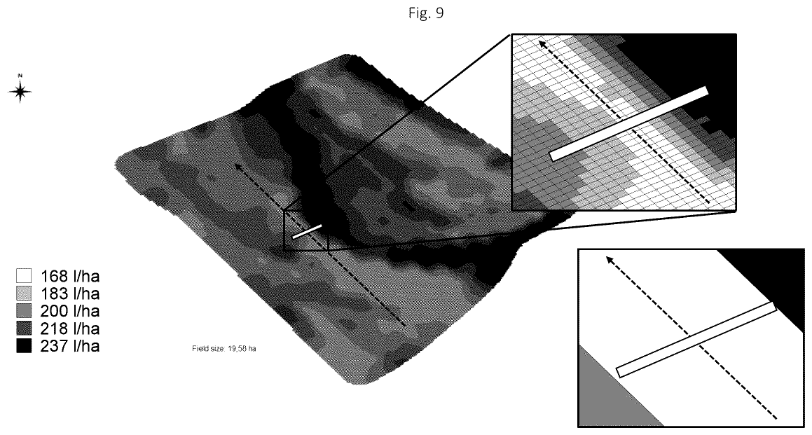

FIG. 9 illustrates product application data, where a grid of application polygons has been generated, wherein the size, the location and/or the shape of the application polygon is based on the product application data, the position and/or movement data, and/or the application configuration parameter data. The two smaller rectangular images highlight a selected area of the application map and demonstrate two different ways of applying a treatment product. In a first case at a high resolution, where the application rate is determined for each application mean, e.g. a sprayer nozzle, and in a second case at a low resolution, where the application rate is only determined at the center of an application device or an application system, e.g. a sprayer.

Since the spatial distribution of areas in the agricultural field with a variable need or with no need of a treatment is inhomogeneous, a plurality of areas of the agricultural field may be over-treated and under-treated in today's common practice of VRA. As can be taken from FIG. 9, the tramline and the application device alone just traverse areas of the agricultural field having a needed amount of treatment product of 168 I/ha. Therefore, the application system only applies a constant amount of treatment product of 168 I/ha onto the agricultural field regardless of whether the application system width covers other areas having another needed amount of treatment product. Hence, some areas of the agricultural field, which are covered by the application system, are under-treated or over treated.

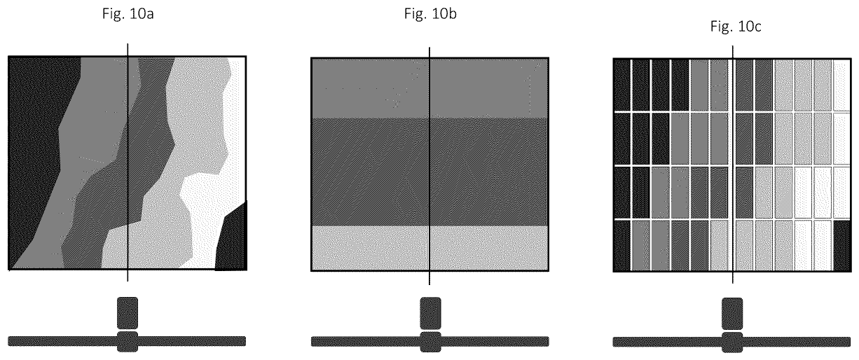

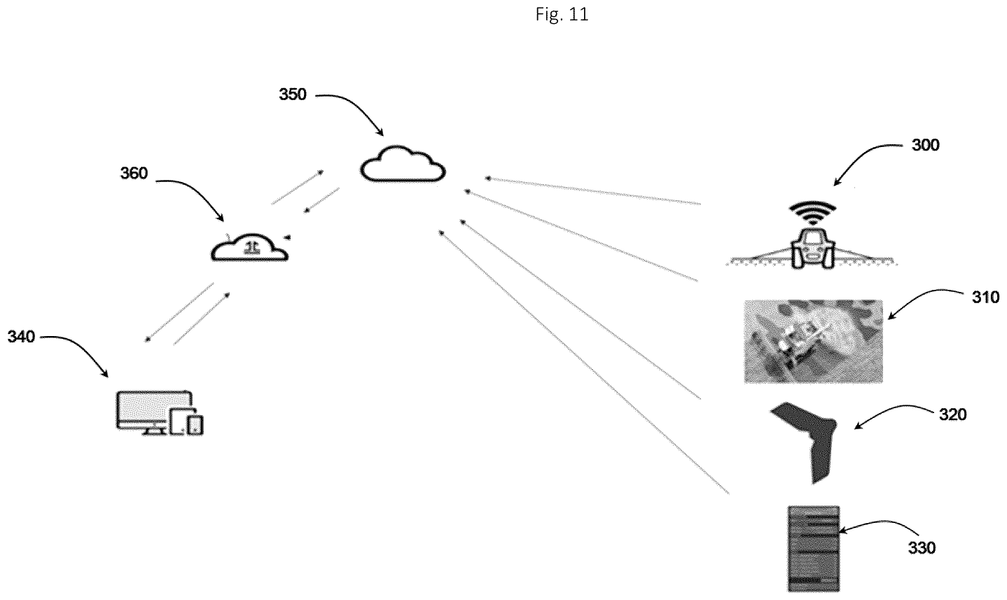

FIGS. 10a, 10b, and 10c illustrate a comparison of the product application data being presented as a heterogeneity map with six different areas (see FIG. 10a) and a map depicting the manner how the application of the treatment product is provided nowadays (see FIG. 10b) and an embodiment of the present invention (see FIG. 10c with a multitude of polygons representing the underlying heterogeneity with a higher resolution). In the current application of the treatment product, the change of the applied amount of treatment product onto the agricultural field is solely based on the position of GNSS receiver of the application device, mostly mounted at the center of the application device, traversing the depicted tramlines with respective needed amounts of treatment product. Therefore, the applied amount of treatment product is identical over the whole application system width and solely changes when the application device GNSS-receiver position enters an area having a different needed amount of treatment product. In the embodiment, the applied amount of treatment product is not identical over the whole application system width and is adapted to the rates derived from the original heterogeneity map allocated to each small polygon.

FIG. 11 illustrates exemplarily the different possibilities to receive and process field data. For example, field data can be obtained by all kinds of agricultural equipment 300 (e.g. a tractor 300) as so-called as-applied maps by recording the application rate at the time of application. It is also possible that such agricultural equipment comprises sensors (e.g. optical sensors, cameras, infrared sensors, various types of soil sensors, etc.) to provide, for example, a weed distribution map, a biomass or soil parameter maps. It is also possible that during harvesting the yield (e.g. in the form of biomass) is recorded by a harvesting vehicle 310. Furthermore, corresponding maps/data can be provided by land-based and/or airborne drones 320 by taking images of the field or a part of it. Finally, it is also possible that a geo-referenced visual assessment 330 is performed and that this field data is also processed. Field data collected in this way can then be merged in a computing device 340, where the data can be transmitted and computed, for example, via any wireless link, cloud applications 350 and/or working platforms 360, wherein the field data may also be processed in whole or in part in the cloud application 350 and/or in the working platform 360 (e.g., by cloud computing).

Aspects of the present disclosure relates to computer program elements configured to carry out steps of the methods described above. The computer program element might therefore be stored on a computing unit of a computing device, which might also be part of an embodiment. This computing unit may be configured to perform or induce performing of the steps of the method described above. Moreover, it may be configured to operate the components of the above described system. The computing unit can be configured to operate automatically and/or to execute the orders of a user. The computing unit may include a data processor. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfill the procedure of an exemplary embodiment of the method as described above. According to a further exemplary embodiment of the present disclosure, a computer readable medium, such as a CD-ROM, USB stick, a downloadable executable or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer-implemented method for providing variable application rate data for at least two application means of an application system of an application device for applying a treatment product onto an agricultural field, comprising:
providing application configuration parameter data for the at least two application means of the application system of the application device;
providing position and/or movement data of the application device;
providing product application data comprising spatial information about the target application amount for the treatment product to be applied onto the agricultural field;
generating a grid of application polygons; and
determining variable application rate data for each of the at least two application means of the application system of the application device based on the application configuration parameter data, the position and/or movement data, and the product application data,
wherein the variable application rate data is determined for each application polygon in the generated grid.

2. The method according to claim 1, wherein the application configuration parameter data comprises information about the width of the application system, the number of application means, the type of the application means, the distance between the application means, the distance of the application means from the application device, the type of control of the application means, the size of the treatment area treatable by the application means, technical properties of the application device and/or the application means, the geometry of the application system and/or the application means, the size of the treatment area, vector data representing the angle and distance of a respective application means to the application device.

3. The method according to claim 1, wherein the position and/or movement data are Global Navigation Satellite System (GNSS), GPS data and/or Real Time Kinematic, RTK, system data and/or accelerometer data and/or gyroscope data of the application device and/or of the application means, and/or wherein the position and/or movement data comprises information about the geographical position of the application device, the geographical position of the application means, the speed of the application device and/or the movement direction of the application device.

4. The method according to claim 1, wherein the step of determining variable application rate data for each one of the at least two application means of the application device comprising:
determining the position and/or movement of each one of the at least two application means based on the application configuration parameter data and the position and/or movement data of the application device; and
determining the variable application rate data based on the position and/or movement of the at least two application means and the product application data/application map for each application polygon

5. The method according to claim 1, wherein the product application data is provided as an application map with polygons, preferably with an optimized polygon size for the treatment product to be applied onto the agricultural field.

6. The method according to claim 1, wherein the product application data and/or the application map is based on the treatment product properties in relation to field heterogeneity, wherein field heterogeneity is based on crop data derived from remote sensing data, long term crop data derived from remote sensing data, soil data derived from measurements of physical and/or chemical and/or biological soil properties through soil samples and/or stationary soil sensors and/or mobile soil sensors, soil data derived from long term remote sensing data, soil data derived from statistical analyses, elevation data and/or slope data derived from digital elevation models and/or digital surface models and/or digital terrain models and/or remote sensing data, crop yield data, in particular weighted or non-weighted crop yield data, long term crop yield data, crop data and/or soil data and/or elevation data and/or slope data and/or crop yield data derived from agricultural implement mounted sensors systems, scouting data of specific weed and/or nematode and/or pest and/or disease infestations derived from cameras and/or drones and/or visual map entries and/or historical data, application data of previous applications of treatment products, a heuristic and/or weighted and/or non-weighted combination of at least two of the preceding datasets.

7. The method according to claim 1, wherein the variable application rate data is determined during a treatment of the agricultural field and/or at the beginning of a treatment of the agricultural field and/or prior to a treatment of the agricultural field.

8. The method according to claim 1, wherein the size, the location and/or the shape of the application polygon is based on the product application data and/or position and/or movement data and/or provided tramlines of the application device and/or the application configuration parameter data as well as the properties of the treatment product

9. The method according to claim 8, wherein the provided tramlines are tramlines provided by an adoption to an actual AB line or determined in the agricultural field.

10. The method according to claim 1, further comprising, providing control data for at least one application means for a variable rate application of a treatment product onto the agricultural field based on the variable application rate data provided as a high resolution polygon grid.

11. A system for providing variable application rate data for at least two application means of an application system of an application device for applying a treatment product onto an agricultural field, comprising:
an application configuration parameter data providing unit for providing application configuration parameter data for the at least two application means of the application system of the application device;
a position and/or movement data providing unit for providing position and/or movement data of the application device;
a product application data providing unit for providing product application data comprising spatial information about the target application amount for the treatment product to be applied onto the agricultural field;
a generating unit for generating a grid of application polygons; and
a determining unit for determining variable application rate data for each one of the at least two application means of the application system of the application device based on the application configuration parameter data, the position and/or movement data, and the product application data, and/or treatment product properties;
wherein the variable application rate data is determined for each application polygon in the generated grid.

12. The system according to claim 11, further comprising:
a control data providing unit for providing control data for at least one application device for a variable rate application of a treatment product which is to be applied onto an agricultural field based on the variable application rate data.

13. An application device for a variable rate application of treatment products onto an agricultural field controlled according to control data according to claim 10, wherein the application device is a sprayer comprising single nozzle control means, section control means, pulse width modulation (PWM) nozzles or automatized switches of multi nozzle heads, a spreader with single outlet control and/or section control and/or a planter/drill with single and/or section seed coulter control.

14. A method for controlling an application device comprising using control data according to claim 10, wherein the application device is a sprayer comprising single nozzle control means, section control means, pulse width modulation (PWM) nozzles or automatized switches of multi nozzle heads, a spreader with single outlet control and/or section control and/or a planter/drill with single and/or section seed coulter control.

15. A computer program element with instructions, which, when executed on computing devices of a computing environment, is configured to carry out the steps of the method according to claim 1 in a system, wherein the system provides variable application rate data for at least two application means of an application system of an application device for applying a treatment product onto an agricultural field, and comprises:
an application configuration parameter data providing unit for providing application configuration parameter data for the at least two application means of the application system of the application device;
a position and/or movement data providing unit for providing position and/or movement data of the application device;
a product application data providing unit for providing product application data comprising spatial information about the target application amount for the treatment product to be applied onto the agricultural field;
a generating unit for generating a grid of application polygons; and
a determining unit for determining variable application rate data for each one of the at least two application means of the application system of the application device based on the application configuration parameter data, the position and/or movement data, and the product application data, and/or treatment product properties;
wherein the variable application rate data is determined for each application polygon in the generated grid.
